(19) United States
(12) Patent Application Publication
(10) Pub. No.: US 2026/0370135 A1
(43) Pub. Date: Nov. 19, 2026

(54) SWITCHING CONTROL CIRCUIT AND POWER SUPPLY CIRCUIT

(71) Applicant: FUJI ELECTRIC CO., LTD., Kawasaki-shi (JP)

(72) Inventor: Ryuji YAMADA, Hachioji-city (JP)

(73) Assignee: FUJI ELECTRIC CO., LTD., Kawasaki-shi (JP)

(21) Appl. No.: 19/577,127

(22) Filed: Mar. 24, 2026

(30) Foreign Application Priority Data
May 16, 2025 (JP) 2025-082523

(51) Int. Cl. H02M 1/42; H02M 1/08; H02M 7/06

(52) U.S. Cl. CPC H02M 1/4208; H02M 1/08; H02M 7/06

(57) ABSTRACT

A switching control circuit for a power supply circuit including an inductor receiving a rectified voltage corresponding to an AC voltage, and a transistor controlling an inductor current flowing through the inductor. The switching control circuit switches the transistor, and includes: a first command value output circuit outputting a first command value, in accordance with the output voltage, the rectified voltage, and the inductor current; a correction circuit correcting the first command value, and output a result thereof as a second command value; a counter outputting a first value that increases discretely, in response to the transistor being turned on; a comparator circuit comparing the second command value and the first value; and a drive signal output circuit outputting a drive signal to drive the transistor, based on a result of the comparison. The correction circuit corrects the first command value every time the transistor is turned off.

### CROSS-REFERENCE TO RELATED APPLICATION

This application claims priority pursuant to 35 U.S.C. §119 from Japanese Patent Application No. 2025-082523, filed on May 16, 2025, of which is incorporated herein by reference.

### BACKGROUND

### Technical Field

The present invention relates to a switching control circuit and a power supply circuit.

### Related Art

Control circuits employing digital control methods may be used in power factor correction circuits (for example, International Publication No. WO2016/047207).

To lower power consumption, control circuits employing digital control method may decrease the clock frequency. Generally, in such control circuits, a time-related command value such as a pulse width generated based on an output voltage is compared with the value of a counter that measures actual time elapsed and the on-time of a transistor included in a power factor correction circuit is determined.

Decreasing the clock frequency to lower power consumption can make the actual time interval longer relative to the interval indicated by the count value of the counter, which may determine an on-time deviating from the desired on-width of the transistor. This may cause the ON-period of the transistor to change stepwise and may cause resonant current to flow through an inductor or an input capacitor in the power factor correction circuit.

### SUMMARY OF THE INVENTION

An aspect of the present disclosure is a switching control circuit for a power supply circuit that generates an output voltage at a target level from an alternating current (AC) voltage, the power supply circuit including an inductor configured to receive a rectified voltage that is in accordance with the alternating current voltage, and a transistor configured to control an inductor current flowing through the inductor, the switching control circuit being configured to switch the transistor of the power supply circuit, the switching control circuit comprising: a first command value output circuit configured to output a first command value, the first command value being in accordance with the output voltage, the rectified voltage, and the inductor current; a correction circuit configured to correct the first command value, and output a result of the correction as a second command value; a counter configured to output a first value that increases discretely, in response to the transistor being turned on; a comparator circuit configured to compare the second command value and the first value; and a drive signal output circuit configured to output a drive signal to drive the transistor, based on a result of the comparison by the comparator circuit, the correction circuit correcting the first command value based on the first command value and the first value and outputting the second command value, every time the transistor is turned off.

An aspect of the present disclosure is a power supply circuit configured to generate an output voltage at a target level from an alternating current (AC) voltage, the power supply circuit comprising: an inductor configured to receive a rectified voltage that is in accordance with the alternating current voltage; a transistor configured to control an inductor current flowing through the inductor; and a switching control circuit configured to switch the transistor, the switching control circuit including a first command value output circuit configured to output a first command value, the first command value output circuit in accordance with the output voltage, the rectified voltage, and the inductor current, a correction circuit configured to correct the first command value, and output a result of the correction as a second command value, a counter configured to output a first value that increases discretely, in response to the transistor being turned on, a comparator circuit configured to compare the second command value and the first value, and a drive signal output circuit configured to output a drive signal to drive the transistor, based on a result of the comparison by the comparator circuit, the correction circuit correcting the first command value based on the first command value and the first value and outputting the second command value, every time the transistor is turned off.

An aspect of the present disclosure is a switching control circuit for a power supply circuit that generates, at an output capacitor, an output voltage at a target level from an alternating current (AC) voltage, the power supply circuit including an inductor configured to receive a rectified voltage that is in accordance with the alternating current voltage, a first transistor configured to control an inductor current flowing through the inductor, and a second transistor provided between the inductor and the output capacitor, the switching control circuit being configured to complementarily switch the first transistor and the second transistor, the switching control circuit comprising: a correction circuit configured to correct a value that is in accordance with the output voltage, and output a result of the correction as a command value; a counter configured to output a count value that increases discretely, in response to the first transistor being turned on; a time period output circuit configured to output a first time period from when the inductor current reaches a predetermined value to when the inductor current reaches a first predetermined value smaller than the predetermined value, in a state where the first transistor is off and the second transistor is on; a comparator circuit configured to compare the command value and the count value; and a drive signal output circuit configured to output a first drive signal to switch the first transistor and a second drive signal to switch the second transistor, the correction circuit correcting the value, based on the value and the count value, and outputting the command value, every time the second transistor is turned on, the drive signal output circuit outputting the second drive signal to turn off the second transistor, in response to the first time period having elapsed since the inductor current reaches the predetermined value after turning off of the first transistor based on a result of the comparison by the comparator circuit, and outputting the first drive signal to turn on the first transistor, in response to the second time period having elapsed, and the second time period being determined based on a parasitic capacitor in the first transistor and a resonant period of the inductor, and being a time period in which a voltage level of an output electrode of the first transistor decreases to a predetermine level.

An aspect of the present disclosure is a power supply circuit configured to generate, at an output capacitor, an output voltage at a target level from an alternating current (AC) voltage, the power supply circuit comprising: an inductor configured to receive a rectified voltage that is in accordance with the alternating current voltage; a first transistor configured to control an inductor current flowing through the inductor; a second transistor provided between the inductor and the output capacitor; and a switching control circuit configured to complementarily switch the first transistor and the second transistor, the switching control circuit including

a correction circuit configured to correct a value that is in accordance with the output voltage, and output a result of the correction as a command value, a counter configured to output a count value that increases discretely, in response to the first transistor being turned on, a time period output circuit configured to output a first time period from when the inductor current reaches a predetermined value to when the inductor current reaches a first predetermined value smaller than the predetermined value, in a state where the first transistor is off and the second transistor is on;

a comparator circuit configured to compare the command value and the count value; and a drive signal output circuit configured to output a first drive signal to switch the first transistor and a second drive signal to switch the second transistor, the correction circuit correcting the value, based on the value and the count value, and outputting the command value, every time the second transistor is turned on, the drive signal output circuit outputting the second drive signal to turn off the second transistor, in response to the first time period having elapsed since the inductor current reaches the predetermined value after turning off of the first transistor based on a result of the comparison by the comparator circuit, and

outputting the first drive signal to turn on the first transistor, in response to the second time period having elapsed, and the second time period being determined based on a parasitic capacitor in the first transistor and a resonant period of the inductor, and being a time period in which a voltage level of an output electrode of the first transistor decreases to a predetermine level.

### BRIEF DESCRIPTION OF THE DRAWINGS

FIG. 1 is a diagram illustrating an example configuration of an AC-DC converter 10a.

FIG. 2 is a diagram illustrating an example configuration of a power factor correction IC 30a.

FIG. 3 is a diagram illustrating an example configuration of a digital circuit 100.

FIG. 4A is a diagram illustrating an example operation of a correction circuit 201.

FIG. 4B is a diagram illustrating an example operation of a correction circuit 201.

FIG. 4C is a diagram illustrating an example operation of a correction circuit 201.

FIG. 5A and FIG. 5B are diagrams illustrating example simulation results.

FIG. 6A and FIG. 6B are diagrams illustrating example simulation results.

FIG. 7 is a diagram illustrating an example configuration of an AC-DC converter 10b.

FIG. 8 is a diagram illustrating an example configuration of a power factor correction IC 30b.

FIG. 9 is a diagram illustrating an example configuration of a digital circuit 101.

FIG. 10 is a diagram illustrating an example operation of a power factor correction IC 30b.

FIG. 11 is a diagram illustrating a path along which an inductor current IL flows in a time period P1.

FIG. 12 is a diagram illustrating a path along which the inductor current IL flows in a time period P2.

FIG. 13 is a diagram illustrating a path along which the inductor current IL flows in a period Px.

FIG. 14A and FIG. 14B are diagrams illustrating example simulation results.

FIG. 15A and FIG. 15B are diagrams illustrating example simulation results.

FIG. 16 is a diagram illustrating an example embodiment of DSP.

### DETAILED DESCRIPTION

At least the following matters will be apparent from description of the present specification and the attached drawings. Hereinafter, identical or equivalent components, members, and the like illustrated in the drawings are denoted by the same reference numerals, and a repeated description thereof may be omitted as appropriate.

### Present Embodiment

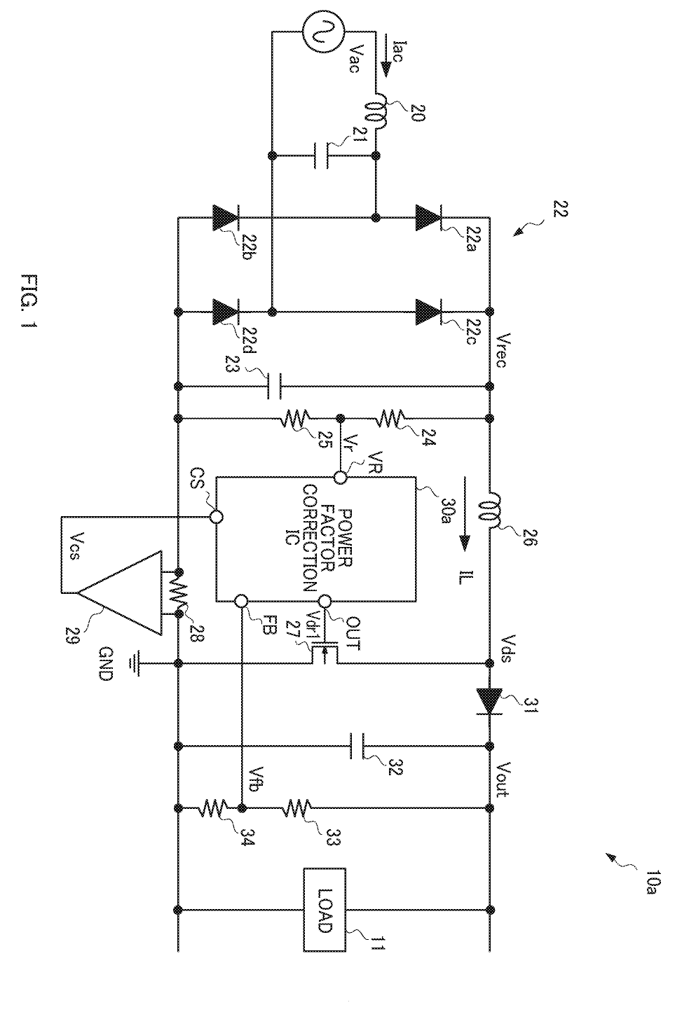

FIG. 1 is a diagram illustrating an example configuration of an AC-DC converter 10a as an embodiment of the present disclosure. The AC-DC converter 10a is a boost chopper power supply circuit that generates an output voltage Vout at a target level from an alternating current (AC) voltage Vac from a commercial power supply. The AC-DC converter 10a applies the output voltage Vout to a load 11, thereby supplying power.

The AC-DC converter 10a includes inductors 20, 26, capacitors 21, 23, 32, a full-wave rectifier circuit 22, resistors 24, 25, 28, 33, 34, an NMOS transistor 27, a voltage detection circuit 29, a power factor correction IC 30a, and a diode 31.

The inductor 20 and the capacitor 21 configure an input filter and restrain noise generated by switching of the NMOS transistor 27 from propagating to the commercial power supply side.

The full-wave rectifier circuit 22 full-wave rectifies a predetermined AC voltage Vac inputted from the input filter and applies the result to the capacitor 23 and the inductor 26 as an input voltage Vrec. Further, the full-wave rectifier circuit 22 is configured by a diode bridge including diodes 22a, 22b, 22c, 22d. Note that the AC voltage Vac is, for example, a voltage with an effective value of 140 V to 240 V and a frequency of 50 Hz to 60 Hz. In the present embodiment below, a voltage is basically a potential difference with respect to a reference point (GND in FIG. 1), but the AC voltage Vac is a voltage across the terminals. A current from the commercial power supply is referred to as an input current Iac.

The capacitor 23 smooths the input voltage Vrec, and the capacitor 32 constitutes a boost chopper circuit together with the inductor 26, the NMOS transistor 27, and the diode 31. Thus, the charging voltage of the capacitor 32 is a direct current (DC) output voltage Vout.

The resistors 24, 25 constitute a voltage divider circuit that divides the input voltage Vrec. A voltage Vr generated at the node of connection between the resistors 24, 25 is applied to a terminal VR of the power factor correction IC 30a (described later).

The NMOS transistor 27 is a switching device for controlling power to the load 11 of the AC-DC converter 10a by controlling an inductor current flowing through the inductor 26. Although the NMOS transistor 27 is an N-type metal oxide semiconductor (NMOS) transistor in the present embodiment, the NMOS transistor 27 may be, for example, a bipolar transistor. The gate electrode of the NMOS transistor 27 is connected to a terminal OUT of the power factor correction IC 30a.

The resistor 28 is a resistor for detecting an inductor current IL flowing thorough the inductor 26 when the NMOS transistor 27 is turned on and has one end connected to the source electrode of the NMOS transistor 27 and the other end connected to a terminal CS of the power factor correction IC 30a.

The inductor current IL flowing in the direction indicated by the arrow in FIG. 1 is referred to as that the inductor current IL flows in a positive direction, and the inductor current IL flowing in a direction opposite from the arrow is referred to as that the inductor current IL flows in a negative direction.

The voltage detection circuit 29 detects a voltage generated at the resistor 28 by the inductor current IL. An output voltage Vcs from the voltage detection circuit 29 is applied to the terminal CS of the power factor correction IC 30a.

The power factor correction IC 30a is an integrated circuit that corrects the power factor of the AC-DC converter 10a and also switches the NMOS transistor 27 so as to bring the level of the output voltage Vout to a target level (e.g., 400 V). Specifically, the power factor correction IC 30a drives the NMOS transistor 27 based on the inductor current IL and the output voltage Vout. The power factor correction IC 30a will be described in detail later. The power factor correction IC 30a is provided with terminals CS, FB, OUT, VR. Note that terminals other than the terminals such as CS of the power factor correction IC 30a are omitted in the present embodiment for convenience.

The resistors 33, 34 constitute a voltage divider circuit that divides the output voltage Vout and generates a feedback voltage Vfb used for switching the NMOS transistor 27. Note that the feedback voltage Vfb generated at the node of connection between the resistors 33, 34 is applied to the terminal FB.

### Resonant Current

Before describing the configuration of the power factor correction IC 30a, how a resonant current flows will be described here. A drain-source voltage Vds of the NMOS transistor 27 repeatedly increases and decreases as the NMOS transistor 27 is turned on and off. Then, after the NMOS transistor 27 continues to be in a state where the ON-period has increased stepwise, the pulse average value of Vds changes stepwise as well.

Then, once the pulse average value of the voltage Vds changes stepwise, a resonant current flows as a step response in a first path passing through the resistor 28, the diode 22d, the capacitor 21, the diode 22a, and the inductor 26 and a second path passing through the resistor 28, the capacitor 23, and the inductor 26. Note that the frequency of the resonant current is often 5 kHz to 6 kHz in a case where the switching frequency of the NMOS transistor 27 is, for example, 65 kHz.

As will be described in more detail later, the power factor correction IC 30a of the present embodiment can reduce the resonant current by using a correction circuit 201 described later.

### Configuration of Power Factor Correction IC 30a

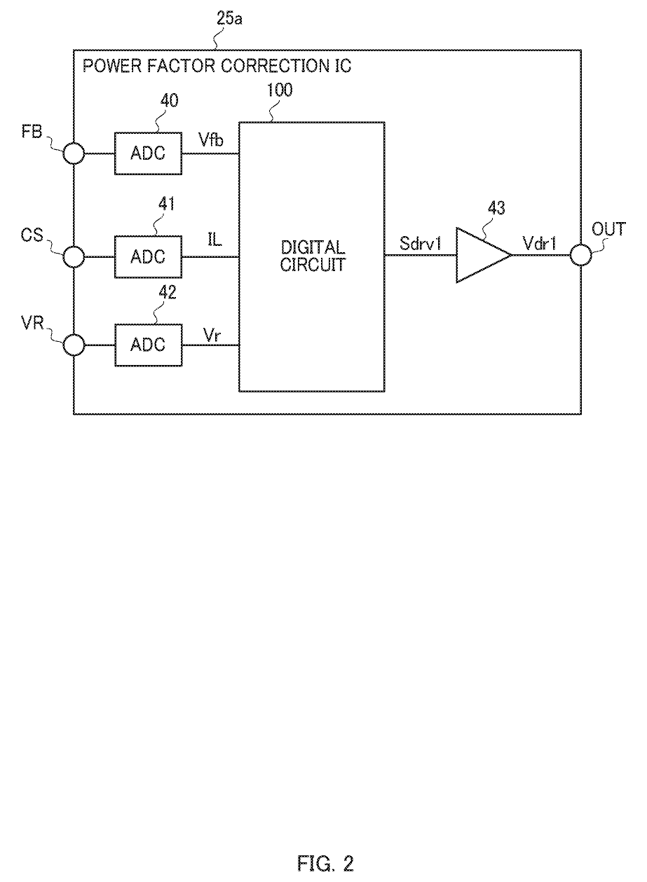

FIG. 2 is a diagram illustrating an example configuration of the power factor correction IC 30a. The power factor correction IC 30a includes an analog-to-digital converters (ADCs) 40, 41, 42, a buffer circuit 43, and a digital circuit 100.

The AD converter 40 converts the feedback voltage Vfb into a digital value. The AD converter 41 converts a voltage, indicating the inductor current IL, detected by the resistor 28 (i.e., the voltage Vcs) into a digital value. The AD converter 42 converts the voltage Vr into a digital value. Note that in the present embodiment, the feedback voltage Vfb converted into a digital value is referred to as the feedback voltage Vfb for convenience. Similarly, a signal, indicating the inductor current IL converted into a digital value, which processed in the digital circuit 100 is referred to the inductor current IL for convenience, and the voltage Vr converted into a digital value is referred to as the voltage Vr for convenience.

The digital circuit 100 outputs a drive signal Sdrv based on the feedback voltage Vfb, the inductor current IL, and the voltage Vr.

The buffer circuit 43 inverts and amplifies the logical level of the drive signal Sdrv, and outputs a voltage Vdr for driving the NMOS transistor 27.

### Digital Circuit 100

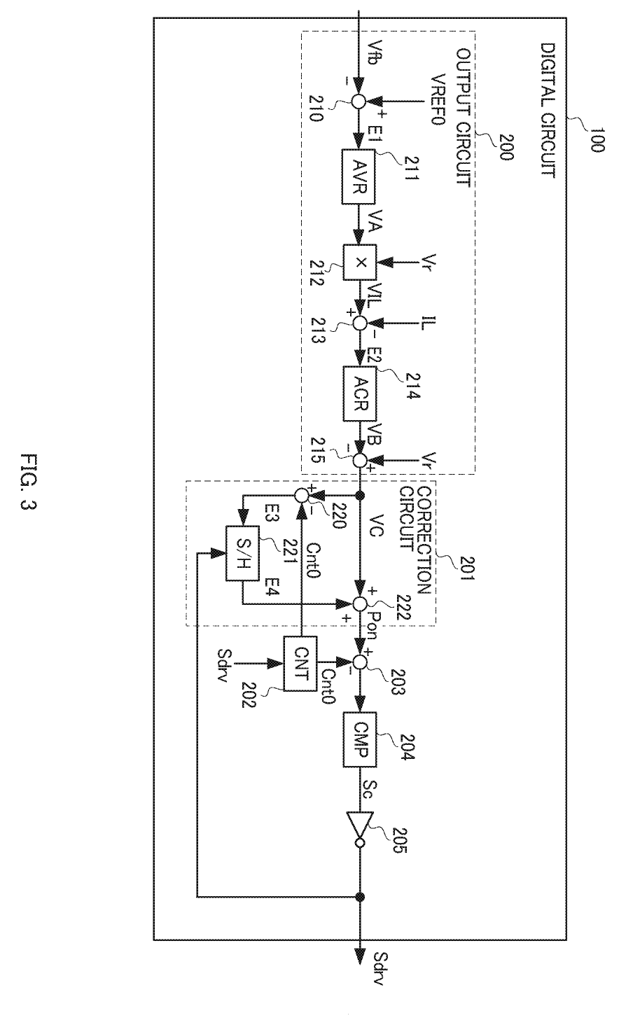

FIG. 3 is a diagram illustrating an example configuration of the digital circuit 100. The digital circuit 100 includes an output circuit 200, the correction circuit 201, a counter 202, a subtractor 203, a comparator 204, and an inverter circuit 205. The digital circuit 100 corresponds to a "switching control circuit."

### Output Circuit 200

The output circuit 200 outputs a voltage VC based on the feedback voltage Vfb, the inductor current IL, and the voltage Vr. Specifically, focusing on the feedback voltage Vfb, the output circuit 200 decreases the voltage VC when the feedback voltage Vfb increases and exceeds a reference voltage VREF0 serving as a reference for the target-level output voltage Vout. Conversely, the output circuit 200 increases the voltage VC when the feedback voltage Vfb decreases and falls below the reference voltage VREF0. The output circuit 200 includes subtractors 210, 213, 215, a voltage regulator (AVR) 211, a multiplier 212, and a current regulator (ACR) 214.

The subtractor 210 calculates an error E1 between the reference voltage VREF0 and the feedback voltage Vfb by subtracting the feedback voltage Vfb from the reference voltage VREF0.

In accordance with the error E1, the voltage regulator 211 outputs a command voltage VA for making the level of the feedback voltage Vfb match the level of the reference voltage VREF0. Note that the subtractor 210 and the voltage regulator 211 correspond to, for example, what is called an error amplifier circuit that performs amplification, integration, and the like on the error E1. Note that the subtractor 210 and the voltage regulator 211 correspond to a "second command value output circuit," and the command voltage VA corresponds to a "third command value."

The multiplier 212 calculates a voltage VIL indicating a command of an instantaneous value of the inductor current IL. Specifically, the multiplier 212 multiplies the voltage VA and the voltage Vr and calculates the voltage VIL for bringing the output voltage Vout to the target level.

The subtractor 213 calculates an error E2 between the voltage VIL and the inductor current IL. Specifically, the subtractor 213 calculates the error E2 between the voltage VIL and the inductor current IL by subtracting the inductor current IL from the voltage VIL.

In accordance with the error E2, the current regulator 214 outputs a voltage VB for making the level of the instantaneous value of the inductor current IL match the level of the voltage VIL. Note that the subtractor 213 and the current regulator 214 correspond to, for example, what is called an error amplification circuit that amplifies the error E2.

The subtractor 215 calculates the voltage VC indicating the difference between the voltage Vr and the voltage VB. Specifically, the subtractor 215 subtracts the voltage VB from the voltage Vr to calculate the voltage VC, which is a differential voltage between the voltage Vr and the voltage VB. The output circuit 200 corresponds to a "first command value output circuit," and the voltage VC corresponds to a "first command value." Further, the subtractor 213, the current regulator 214, and the subtractor 215 correspond to a "third command value output circuit."

### Correction Circuit 201

Every time the NMOS transistor 27 is turned off, the correction circuit 201 outputs a voltage indicating an ON-period command Pon based on the voltage VC and a count value Cnt0, from the counter 202 (described later). Specifically, every time the NMOS transistor 27 is turned off, the correction circuit 201 corrects the voltage VC based on the error between the voltage VC and the count value Cnt0, and outputs the result as the ON-period command Pon. The correction circuit 201 includes a subtractor 220, a sample-and-hold circuit (S/H) 221, and an adder 222.

The subtractor 220 subtracts the count value Cnt0 of the counter 202 from the voltage VC and outputs the result as an error E3.

When the NMOS transistor 27 is turned off, the sample hold circuit 221 samples the error E3 and holds it as an error E4 and outputs the error E4. Note that the sample-and-hold circuit 221 corresponds to a "sample-and-hold circuit," and the error E4 corresponds to a "second value."

The adder 222 adds the voltage VC and the error E4 and outputs the result as the ON-period command Pon. The ON-period command Pon corresponds to a "second command value."

### Counter 202

When the NMOS transistor 27 is turned on, i.e., when the digital circuit 100 outputs the drive signal Sdrv at a high level (hereinafter referred to as high or high level), the counter 202 counts the discretely increasing count value Cnt0 at a predetermined period corresponding to the switching frequency of the NMOS transistor 27 and outputs the count value Cnt0. The counter 202 corresponds to a "counter," and the count value Cnt0 corresponds to a "first value."

### Subtractor 203 and Comparator 204

The subtractor 203 subtracts the count value Cnt0 from the ON-period command Pon. The comparator 204 outputs a signal Sc based on the subtraction result from the subtractor 203. The subtractor 203 and the comparator 204 correspond to a "comparator circuit."

### Inverter Circuit 205

The inverter circuit 205 inverts the logical level of the signal Sc, which is the comparison result from the comparator 204, and outputs the drive signal Sdrv. The inverter circuit 205 corresponds to a "drive signal output circuit."

### Operation of Correction Circuit 201

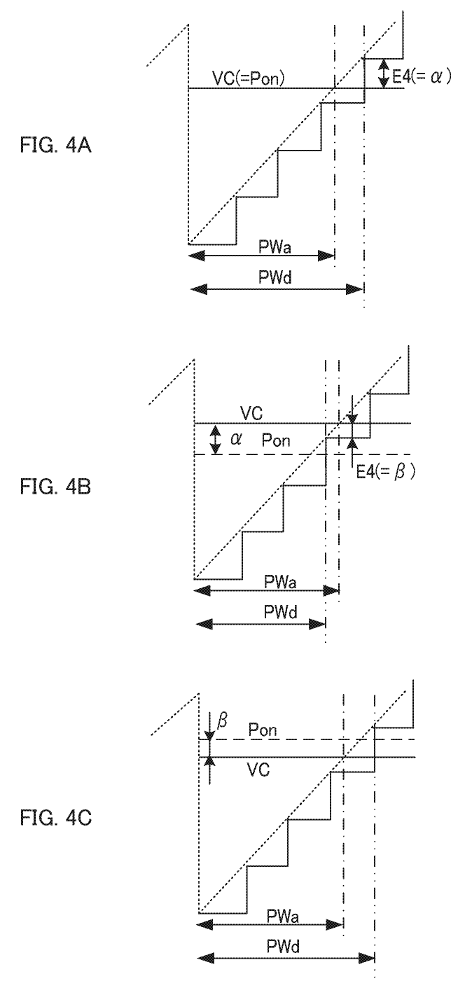

FIGS. 4A to 4C are diagrams illustrating an example operation of the correction circuit 201. Note that FIG. 4A is a diagram illustrating an initial state where the voltage VC is equal to the ON-period command Pon. FIG. 4B is a diagram illustrating how the ON-period command Pon changes after the operation in FIG. 4A. Similarly, FIG. 4C is a diagram illustrating how the ON-period command Pon changes after the operation in FIG. 4B. The dotted lines represent a ramp wave in a case where the power factor correction IC 30a is controlled analogically, and the solid lines increasing stepwise represent the count value Cnt0.

In FIG. 4A, the voltage VC and the ON-period command Pon match. Then, the time period from when the ramp wave starts increasing to when the ramp wave exceeds the ON-period command Pon is an ON-period PWa in a case where the power factor correction IC 30a is analogically controlled. In contrast, in a case where the power factor correction IC 30a is digitally controlled, the count value Cnt0 increases in discrete steps, causing the error E4 (denoted as α here) between the count value Cnt0 and the ON-period command Pon. Thus, in FIG. 4A, an ON-period PWd in a case where the power factor correction IC 30a is digitally controlled is longer than the ON-period PWa.

Then, at the timing when the NMOS transistor 27 is turned off after a lapse of the ON-period PWd, the sample-and-hold circuit 221 outputs the error E4 (i.e., α). Then, the adder 222 adds the voltage VC and α that is a negative value, and outputs the ON-period command Pon. Thus, the ON-period command Pon is at a level lower than the voltage VC by α. In FIG. 4B, the ON-period PWd is shorter than the ON-period PWa.

Then, at the timing when the NMOS transistor 27 is turned off after a lapse of the ON-period PWd, the sample-and-hold circuit 221 outputs the error E4 (referred to as β here). Then, the adder 222 adds the voltage VC and β that is a positive value, and outputs the ON-period command Pon. Thus, the ON-period command Pon is at a level higher than the voltage VC by β. In FIG. 4C, the ON-period PWd is longer than the ON-period PWa.

When the ON-period command Pon is thus changed based on the error E4 between the count value Cnt0 and the voltage VC at the timing when the NMOS transistor 27 is turned off, the ON-period PWd increases and decreases at a shorter interval than the resonant period of the filter, causing the average ON-period of the NMOS transistor 27 relative to the resonant period not to change stepwise.

Accordingly, a switching circuit capable of reducing resonant current can be provided.

### Simulation Results

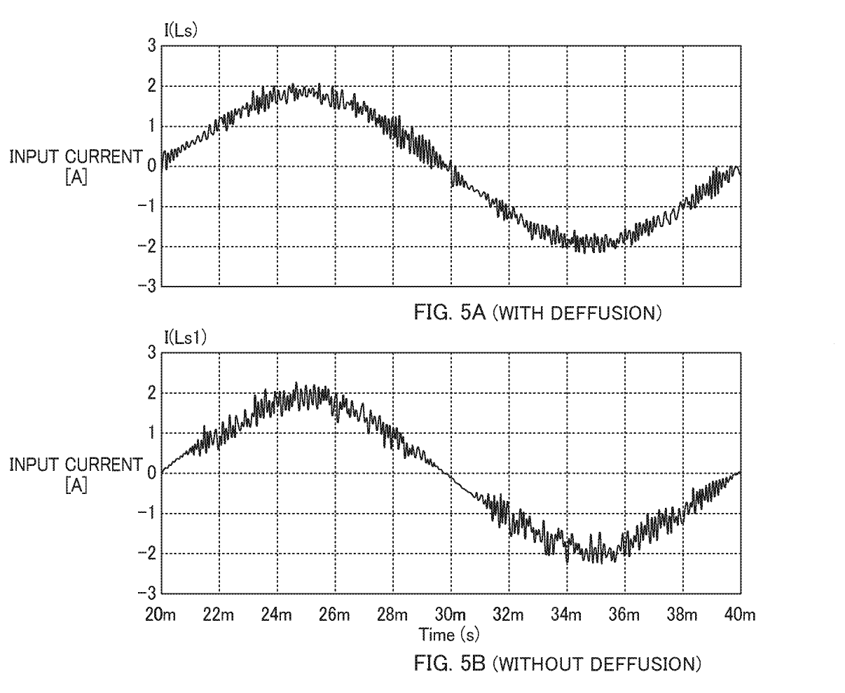

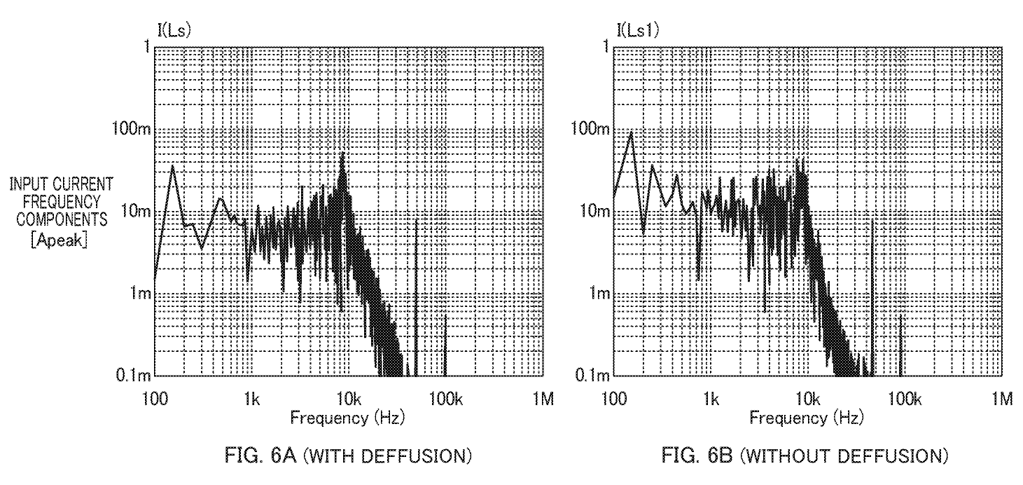

FIGS. 5A, 5B, 6A and 6B show example simulation results. The diagram in FIG. 5A shows the current Iac in a case where the ON-period command Pon is the ON-period command value, and the diagram in FIG. 5B shows the current Iac in a case where the voltage VC is the ON-period command value. The diagram in FIG. 6A shows a frequency component of the current Iac in a case where the ON-period command Pon is the ON-period command value, and the diagram in FIG. 6B shows a frequency component of the current Iac in a case where the voltage VC is the ON-period command value.

The effectiveness of the correction circuit 201 is not clearly observable in a comparison between the diagrams in FIGS. 5A and 5B but is observable in a comparison between the diagrams in FIGS. 6A and 6B. Specifically, the diagrams show that a frequency component of the input current Iac decreases around the frequency of the resonant current (e.g., 10 kHz or below). In other words, a LC resonance of the filter is reduced when the ON-period command Pon is the ON-period command value, compared to when the voltage VC is the ON-period command value. Accordingly, the resonant current is reduced by the correction circuit 201.

### Modification Examples

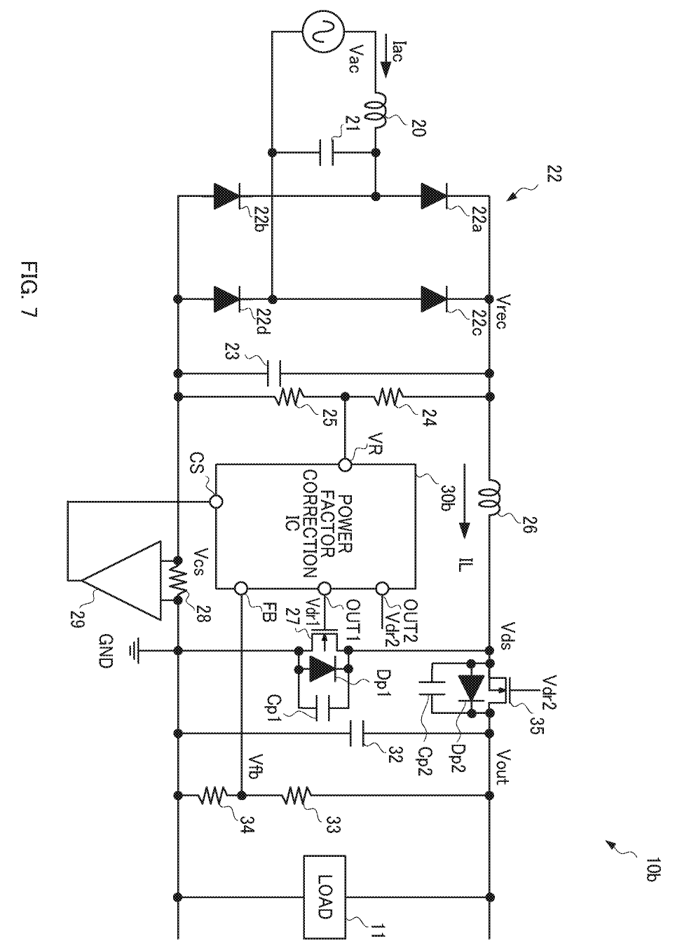

FIG. 7 is a diagram illustrating an example configuration of an AC-DC converter 10b as another embodiment of the present disclosure. The AC-DC converter 10b is a boost chopper power supply circuit that generates the output voltage Vout at a target level from an AC voltage Vac from a commercial power supply. Note that the AC-DC converter 10b applies the output voltage Vout to the load 11, thereby supplying power. Further, as will be described in detail later, the AC-DC converter 10b includes the NMOS transistor 27 (described later) and an NMOS transistor 35 for synchronous rectification and operates as a power factor correction circuit that operates in critical mode. "Critical mode" is a mode where switching is turned on after the inductor current IL as described later reaches zero.

The AC-DC converter 10b includes the inductors 20, 26, the capacitors 21, 23, 32, the full-wave rectifier circuit 22, the resistors 24, 25, 28, 33, 34, the NMOS transistors 27, 35, the voltage detection circuit 29, and a power factor correction IC 30b. The capacitor 32 corresponds to an "output capacitor."

The gate electrode of the NMOS transistor 27 is connected to a terminal OUT1 of the power factor correction IC 30b. The NMOS transistor 27 has a parasitic diode Dp1 and a parasitic capacitor Cp1. The NMOS transistor 27 corresponds to a "first transistor," and the drain electrode of the NMOS transistor 27 corresponds to an "output electrode."

The inductor current IL flowing in the direction indicated by the arrow in FIG. 7 is referred to as that the inductor current IL flows in a positive direction, and the inductor current IL flowing in a direction opposite from the arrow is referred to as that the inductor current IL flows in a negative direction.

The power factor correction IC 30b is an integrated circuit that corrects the power factor of the AC-DC converter 10b and also complementarily switches the NMOS transistor 27 and the NMOS transistor 35 for synchronous rectification to bring the level of the output voltage Vout to a target level (e.g., 400 V). Specifically, the power factor correction IC 30b drives the NMOS transistor 27 based on the inductor current IL and the output voltage Vout. The power factor correction IC 30b will be described in detail later. The power factor correction IC 30b is provided with terminals CS, FB, OUT1, OUT2, VR. Note that terminals other than the terminals such as CS of the power factor correction IC 30b are omitted in the present embodiment for convenience.

The NMOS transistor 35 is a transistor for synchronous rectification provided between the inductor 26 and the capacitor 32 and is switched complementarily with the NMOS transistor 27. The gate electrode of the NMOS transistor 35 is connected to the terminal OUT2 of the power factor correction IC 30b. Further, as will be described in detail later, when the NMOS transistor 27 is turned off, the NMOS transistor 35 is turned on so that the inductor current IL from the inductor 26 may flow through the capacitor 32. The NMOS transistor 35 has a parasitic diode Dp2 and a parasitic capacitor Cp2. The NMOS transistor 35 corresponds to a "second transistor."

### Configuration of Power Factor Correction IC 30b

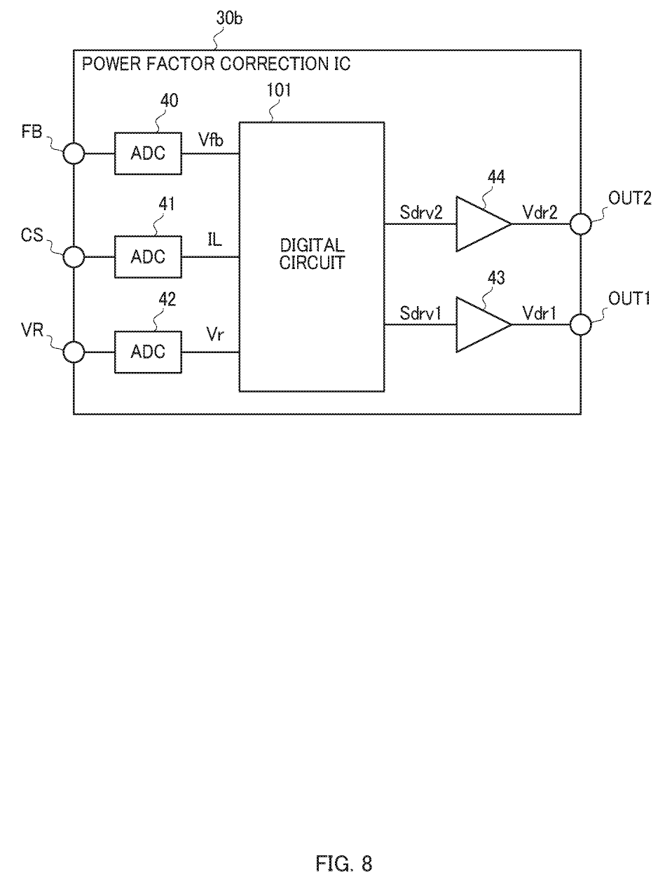

FIG. 8 is a diagram illustrating an example configuration of the power factor correction IC 30b. The power factor correction IC 30b includes the analog-to-digital converters (ADCs) 40, 41, 42, buffer circuits 43, 44, and a digital circuit 101.

The digital circuit 101 outputs drive signals Sdrv1, Sdrv2 based on the feedback voltage Vfb, the inductor current IL, and the voltage Vr.

The buffer circuit 44 amplifies the drive signal Sdrv2 and outputs the voltage Vdr2 for driving the NMOS transistor 35.

### Digital Circuit 101

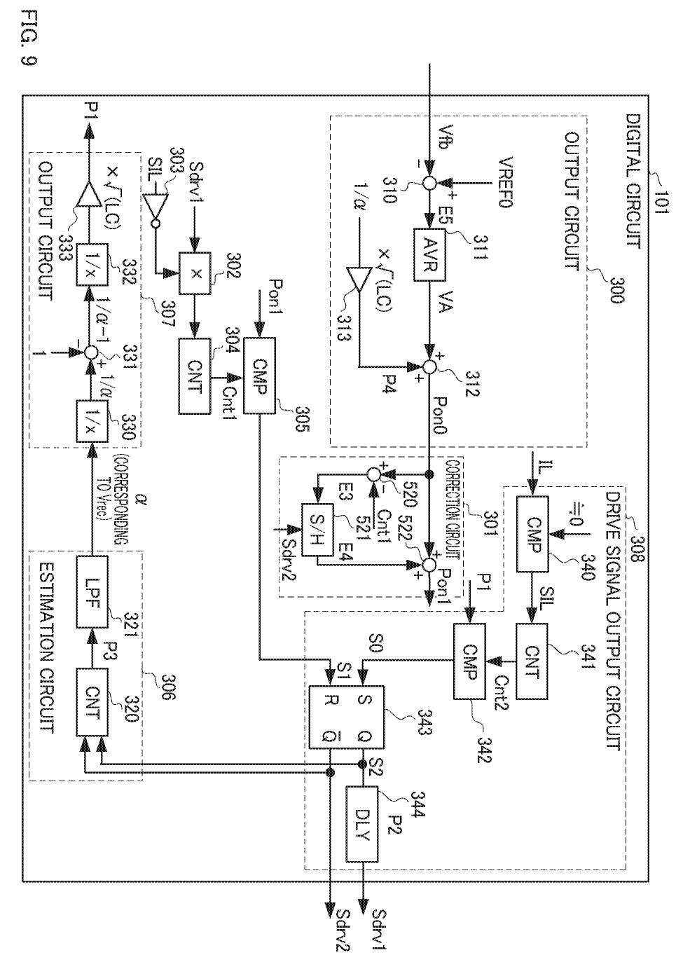

FIG. 9 is a diagram illustrating an example configuration of the digital circuit 101. The digital circuit 101 switches the NMOS transistors 27, 35 complementarily. The digital circuit 101 outputs the drive signals Sdrv1, Sdrv2 based on the feedback voltage Vfb, the inductor current IL, and the voltage Vr. The digital circuit 101 corresponds to the "switching control circuit."

In the following, "L" denotes the inductance value of the inductor 26, and a "capacitance value C" denotes the capacitance value obtained by combining the capacitance value of the parasitic capacitor Cp1 of the NMOS transistor 27 and the capacitance value of the parasitic capacitor Cp2 of the NMOS transistor 35. Although the "capacitance value C" here is the combined capacitance value of the parasitic capacitors in the NMOS transistors 27, 35, in a case where capacitors are additionally provided in parallel to the respective NMOS transistors 27, 35, "C" is the capacitance value combining the capacitance values of those capacitors as well.

The digital circuit 101 includes output circuits 300, 307, a correction circuit 301, a multiplier 302, an inverter circuit 303, a counter 304, a comparator 305, an estimation circuit 306, and a drive signal output circuit 308.

### Output Circuit 300

Based on the feedback voltage Vfb, the output circuit 300 outputs a voltage indicating the ON-period command Pon0 for the NMOS transistor 27. Specifically, the output circuit 300 decreases the ON-period command Pon0 when the feedback voltage Vfb increases and exceeds the reference voltage VREF0 serving as a reference for the target-level output voltage Vout. In contrast, the output circuit 300 increases the ON-period command Pon0 when the feedback voltage Vfb decreases and falls below the reference voltage VREF0.

The output circuit 300 includes a subtractor 310, a voltage regulator (AVR) 311, an adder 312, and an amplifier 313.

The subtractor 310 calculates an error E5 between the reference voltage VREF0 and the feedback voltage Vfb by subtracting the feedback voltage Vfb from the reference voltage VREF0.

In accordance with the error E5, the voltage regulator 311 outputs the command voltage VA for making the level of the feedback voltage Vfb match the level of the reference voltage VREF0. Note that the subtractor 310 and the voltage regulator 311 correspond to, for example, what is called an error amplifier circuit that performs amplification, integration, and the like on the error E5.

The adder 312 adds the command voltage VA and a voltage indicating a time period P4 from the amplifier 313 to be described later and outputs the addition result as a voltage indicating the ON-period command Pon0.

Accordingly, by outputting a larger or smaller ON-period command Pon0 in accordance with an increase or decrease of the output voltage Vout to maintain the output voltage Vout at the target level, the output circuit 300 controls the inductor current IL.

Thus, the waveform of the average value of the inductor current IL is similar in shape to that of the rectified voltage Vrec, and the digital circuit 101 improves the power factor. In other words, the waveform of the averaged unput current Iac is also similar in shape to that of the AC voltage Vac, and the power factor of the AC-DC converter 10b is improved.

The amplifier 313 outputs a voltage indicating the time period P4 based on the rectified voltage Vrec and the resonant period. Specifically, the amplifier 313 amplifies 1/α, which is the reciprocal of the value α from a divider 330 to be described later, by a factor of √(LC) and outputs a voltage indicating the time period P4. Note that the value α is determined based not only on a period from when the NMOS transistor 27 is turned off to when the NMOS transistor 35 is turned off, but also on the period in which the combined capacitance of the parasitic capacitors Cp1, Cp2 is discharged. Further, √(LC) is a value based on the resonant period 2π√(LC). Note that the ON-period command Pon0 corresponds to a "value."

### Correction Circuit 301

Every time the NMOS transistor 27 is turned off, the correction circuit 301 outputs a voltage indicating an ON-period command Pon1 based on the voltage indicating the ON-period command Pon0 and a count value Cnt1 from the counter 304 (described later). Specifically, every time the NMOS transistor 27 is turned off, the correction circuit 301 corrects the voltage indicating the ON-period command Pon0 based on an error between the voltage indicating the ON-period command Pon0 and the count value Cnt1, and outputs the result as a voltage indicating the ON-period command Pon1.

The correction circuit 301 includes a subtractor 520, a sample-and-hold circuit (S/H) 521, and an adder 522.

The subtractor 520 subtracts the count value Cnt1 from the ON-period command Pon0 from the counter 304 (described later) and outputs the result as the error E3.

When the NMOS transistor 27 is turned off, the sample-and-hold circuit 521 samples the error E3, holds it as the error E4, and outputs the error E4.

The adder 522 adds the ON-period command Pon0 and the error E4 and outputs the result as the ON-period command Pon1. The ON-period command Pon1 corresponds to a "command value."

### Multiplier 302, Inverter Circuit 303, and Counter 304

The multiplier 302 multiplies the drive signal Sdrv1 and a signal obtained by the inverter circuit 303 that inverts a signal SIL (described later), and outputs the result to the counter 304. In other words, when the signal SIL is high, i.e., when the inductor current IL is smaller than a predetermined value (described later), the multiplier 302 resets the counter 304 and stops its operation.

In contrast, when the signal SIL is low, i.e., when the inductor current IL is larger than the predetermined value, the multiplier 302 has the counter 304 measure the time period in which the drive signal Sdrv1 is high.

When the inductor current IL is larger than the predetermined value, the counter 304 measures the time period in which the drive signal Sdrv1 is high and outputs the result as a voltage indicating the count value Cnt1 that increases in discrete steps. In contrast, when the inductor current IL is smaller than the predetermined value, the counter 304 is reset and does not operate. The counter 304 corresponds to a "counter," and the count value Cnt1 corresponds to a "count value."

### Comparator 305

The comparator 305 determines the magnitude relation between the voltage indicating the count value Cnt1 and the voltage indicating the ON-period command Pon1. The comparator 305 outputs a high signal S1 when the count value Cnt1 exceeds the ON-period command Pon1 and outputs a low signal S1 when the count value Cnt1 is smaller than the ON-period command Pon1. The comparator 305 corresponds to a "comparator circuit."

The estimation circuit 306 is a circuit that estimates the rectified voltage Vrec and outputs the value α based on a time period P3 from when the NMOS transistor 27 is turned off to when the NMOS transistor 35 is turned off. The estimation circuit 306 includes a counter (CNT) 320 and a low pass filter (LPF) 321.

The counter 320 measures the time period from when the Q output of an SR flip-flop 343 described later goes to a low level (hereinafter referred to as low or low level) to when the Q-bar output goes low. Then, the counter 320 outputs the count result as a voltage indicating the time period P3.

In a case where the output voltage Vout is maintained at the target level and the ON-period command Pon1 is almost constant, the peak value of the inductor current IL is larger when the phase angle (or the voltage level) of the rectified voltage Vrec is higher and is smaller when the phase angle of the rectified voltage Vrec is lower.

Then, the time period from when the NMOS transistor 27 is turned off to when the inductor current IL stops flowing is longer when the phase angle of the rectified voltage Vrec is higher, and is shorter when the phase angle of the rectified voltage Vrec is lower. Thus, in a case where the AC-DC converter 10b operates in critical mode, the time period P3 is longer when the phase angle of the rectified voltage Vrec is higher, and is shorter when the phase angle of the rectified voltage Vrec is lower. Accordingly, the time period P3 is a time period based on an AC component (or voltage level) of the rectified voltage Vrec.

What is meant by the phase angle of the rectified voltage Vrec being "high" is that an angle expressed as the phase angle of the AC voltage Vac falls within the range of, for example, 90 ±10 + 180n degrees, i.e., (80 to 100) + 180n degrees. On the other hand, what is meant by the phase angle of the rectified voltage Vrec being "low" is that the angle falls within the range of, for example, 0 ±10 + 180n degrees, i.e., (-10 to +10) + 180n degrees. Here, n is an integer.

The low pass filter 321 integrates the voltage in accordance with the time period P3 and outputs the value α. Thus, the value α is the rectified voltage Vrec estimated based on the time period P3.

### Output Circuit 307

The output circuit 307 outputs a voltage indicating a time period P1 to be described later based on the estimated rectified voltage Vrec, the resonant period, and the output voltage Vout and includes dividers 330, 332, a subtractor 331, and an amplifier 333.

The divider 330 computes the reciprocal of the value α and outputs a voltage indicating 1/α.

The subtractor 331 subtracts 1 from 1/α and outputs a voltage indicating 1/α ― 1.

The divider 332 computes the reciprocal of 1/α ― 1 and outputs a voltage indicating 1/(1/α ― 1).

The amplifier 333 amplifies 1/(1/α ― 1) by a factor of √(LC) and outputs the result as a voltage indicating the time period P1. Further, as will be described later in detail, the time period P1 is a time period from when the inductor current IL reaches a predetermined value (e.g., zero ampere) to when the inductor current IL reaches a current value I0 smaller than the predetermined value, with the NMOS transistor 27 off and the NMOS transistor 35 on. The output circuit 307 may output the time period P1 further using a discharging period of the parasitic capacitor Cp1. The output circuit 307 corresponds to a "time period output circuit," the time period P1 corresponds to a "first time period," and the current value I0 corresponds to a "first predetermined value."

### Drive Signal Output Circuit 308

The drive signal output circuit 308 outputs the drive signal Sdrv1 for switching the NMOS transistor 27 and the drive signal Sdrv2 that switches the NMOS transistor 35 based on the inductor current IL, the ON-period command Pon1, and the time period P1. The drive signal Sdrv1 corresponds to a "first drive signal," and the drive signal Sdrv2 corresponds to a "second drive signal.

The drive signal output circuit 308 includes comparators (CMPs) 340, 342, a counter 341, the SR flip-flop 343, and a delay circuit (DLY) 344.

The comparator 340 detects when the inductor current IL falls below a predetermined value. Specifically, the comparator 340 outputs a high signal SIL when the inductor current IL falls below the predetermined value (e.g., almost zero), and outputs a low signal SIL when the inductor current IL is larger than the predetermined value.

The counter 341 measures the time period in which the high signal SIL is inputted and outputs a voltage indicating a count value Cnt2. On the other hand, the counter 341 is reset when the low signal SIL is inputted.

The comparator 342 determines the magnitude relation between the voltage indicating the count value Cnt2 and the voltage indicating the time period P1. The comparator 342 outputs a high signal S0 when the count value Cnt2 exceeds the time period P1 and outputs a low signal S0 when the count value Cnt2 is smaller than the time period P1. Thus, as will be described later, the drive signal output circuit 308 outputs the drive signal Sdrv2 that turns off the NMOS transistor 35 when the time period P1 has elapsed since the inductor current reached the predetermined value with the NMOS transistor 27 off.

Based on the signal S0 from the comparator 342 and the signal S1 from the comparator 305 (i.e., a comparison result from the comparator 305), the SR flip-flop 343 outputs a signal S2 and the drive signal Sdrv2. Specifically, when the comparator 342 outputs the high signal S0, the SR flip-flop 343 outputs a high signal S2 and a low drive signal Sdrv2.

On the other hand, when the comparator 305 outputs the high signal S1, the SR flip-flop 343 outputs the low signal S2 and a high drive signal Sdrv2.

The SR flip-flop 343 does not change the logical levels of the signal S2 and the drive signal Sdrv2 when the signals S0, S1 outputted from the comparators 342, 305 are both at low level. Further, although the SR flip-flop 343 outputs the high drive signal Sdrv2 at the same time as the low signal S2 above, a dead time may be provided. In this case, the SR flip-flop 343 outputs the low signal S2, and then outputs the high drive signal Sdrv2 after a dead time has elapsed.

When the signal S2 is high, the delay circuit 344 delays the signal S2 by a time period P2 and outputs a result as the drive signal Sdrv1. In contrast, when the low signal S2 is inputted, the delay circuit 344 outputs a low drive signal Sdrv1 without delaying the signal S2. Accordingly, the drive signal output circuit 308 outputs the drive signal Sdrv1 to turn on the NMOS transistor 27, in response to the time periods P1 and P2 having elapsed since the inductor current reaches a predetermined value after turning off of the NMOS transistor 27. Note that the time period P2 corresponds to the discharging period of the parasitic capacitors Cp1, Cp2 and is determined based on the resonant period of the parasitic capacitor Cp1 and the inductor 26. Further, the time period P2 corresponds to a "second time period."

### Operation of Power Factor Correction IC 30b and Time Periods P1, P2, Pon1

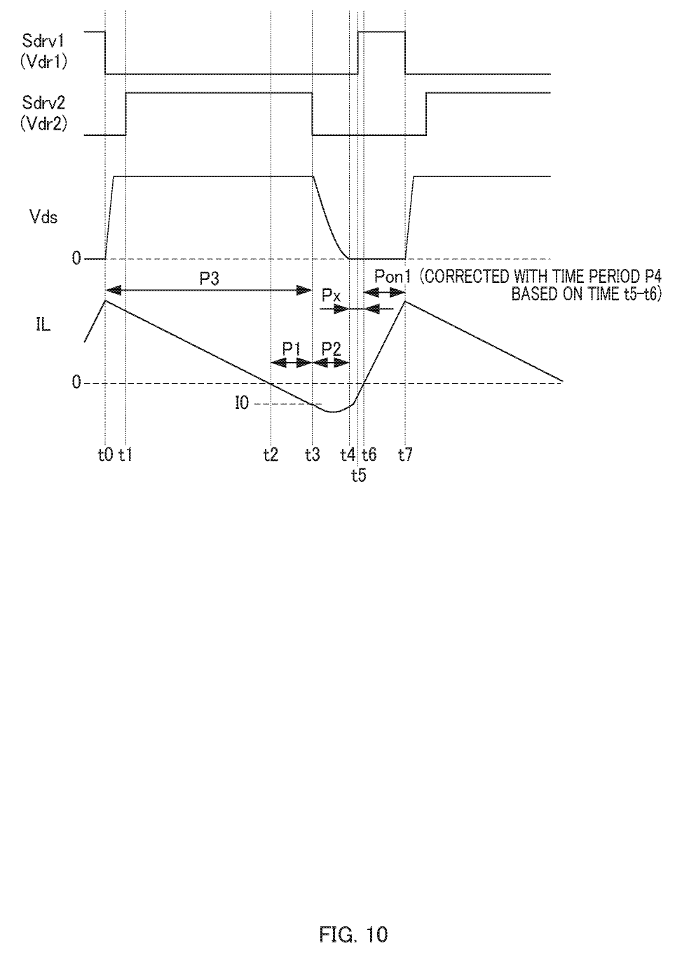

FIG. 10 is a diagram illustrating an example operation of the power factor correction IC 30b. The following describes the operation of the power factor correction IC 30b as well as the periods P1, P2, Pon1.

At time t0, the delay circuit 344 outputs a low drive signal Sdrv1 and turns off the NMOS transistor 27. Because the NMOS transistor 27 is turned off, the current value of the inductor current IL that flows in the positive direction starts decreasing. Further, because the parasitic diode Dp2 in the NMOS transistor 35 in FIG. 1 is turned on, the voltage Vds increases to a voltage close to the output voltage Vout.

At time t1 at which a dead time has elapsed since time t0, the SR flip-flop 343 outputs a high drive signal Sdrv2 and turns on the NMOS transistor 35. Accordingly, the inductor current IL flows through the capacitor 32 via the NMOS transistor 35 instead of via the parasitic diode Dp2.

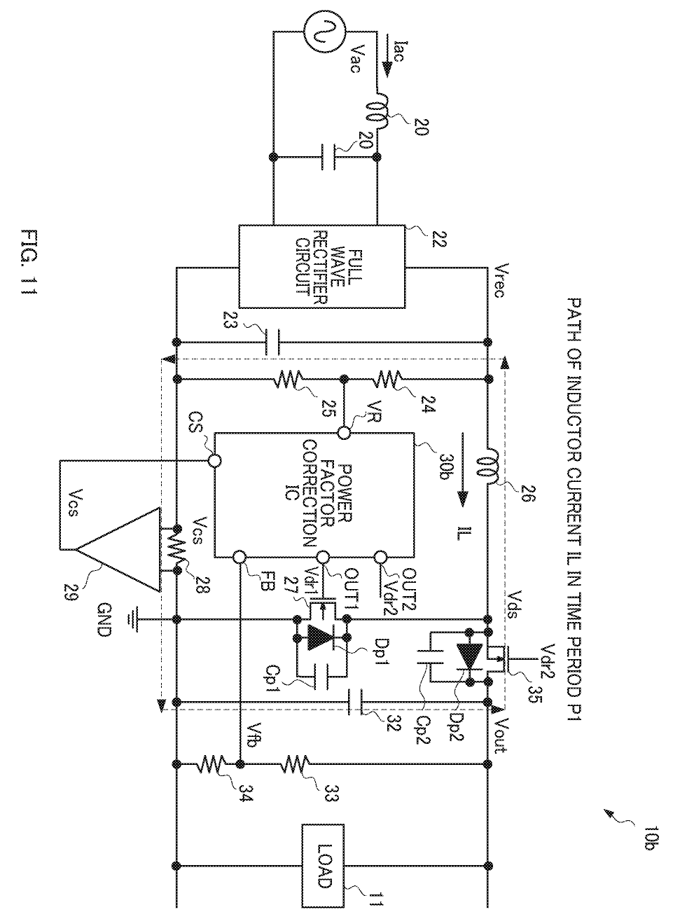

At time t2, the inductor current IL reaches a predetermined value. The comparator 340 outputs a high signal SIL, and the counter 341 starts counting. After that, the inductor current IL flows in the negative direction. Specifically, in the time period P1 that starts at time t2, the output voltage Vout generated at the capacitor 32 has a higher voltage level than the rectified voltage Vrec; thus, the inductor current IL flows from the capacitor 32 to the inductor 26 via the NMOS transistor 35 and then flows to the capacitor 32 via the capacitor 23, as shown in FIG. 11.

At time t3 at which the time period P1 has elapsed since time t2, the voltage indicating the count value Cnt2 of the counter 341 exceeds the voltage indicating the time period P1, and the comparator 342 outputs a high signal S0 and the SR flip-flop 343 outputs a high signal S2 and a low drive signal Sdrv2. The NMOS transistor 35 is then turned off. After that, the voltage Vds starts decreasing.

The time period P1 is a time period starting at time t2 that is from when the inductor current IL starts flowing in the negative direction to when its current value reaches a negative current value I0. The current value I0 is then almost ―√(C/L) × Vrec. Further, the time period P1 changes in accordance with the voltage of the rectified voltage Vrec, i.e., the value α. Specifically, the time period P1 is computed to be √(LC)/(1/α ― 1).

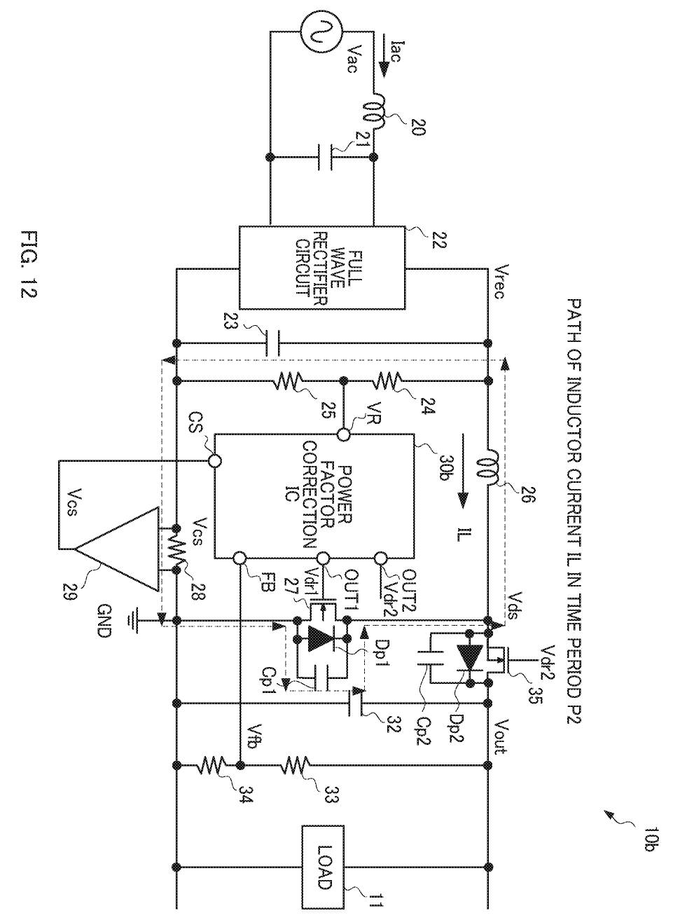

Further, in the time period P2 starting at time t3, the NMOS transistor 35 is turned off, but the inductor 26 keeps the inductor current IL flowing in the negative direction. Thus, as shown in FIG. 12, the inductor current IL flows from the parasitic capacitor Cp1 to the parasitic capacitor Cp1 via the inductor 26 and the capacitor 23. Note that the period from time t0 to time t3 is the time period P3.

At time t4 at which the time period P2 has elapsed since time t3, the voltage Vds decreases around a predetermined level (e.g., zero volt). After that, the delay circuit 344 outputs a high drive signal Sdrv1 to turn on the NMOS transistor 27, and switching loss of the NMOS transistor 27 is reduced irrespective of the voltage level of the rectified voltage Vrec.

Here, the time period P2 is a time period in which the parasitic capacitor Cp1 is discharged with the NMOS transistors 27, 35 both being off, decreasing the voltage Vds. Further, the time period P2 is a predetermined period irrespective of the voltage level of the rectified voltage Vrec. Specifically, the time period P2 is √(LC).

At time t5, the delay circuit 344 outputs a high drive signal Sdrv1, and turns on the NMOS transistor 27. Accordingly, because the NMOS transistor 27 is turned on when the voltage Vds is around zero volt, zero-volt switching (ZVS) is achieved.

At time t6, the inductor current IL exceeds a predetermined value. Thus, the counter 304 measures the time period in which the delay circuit 344 outputs the high drive signal Sdrv1.

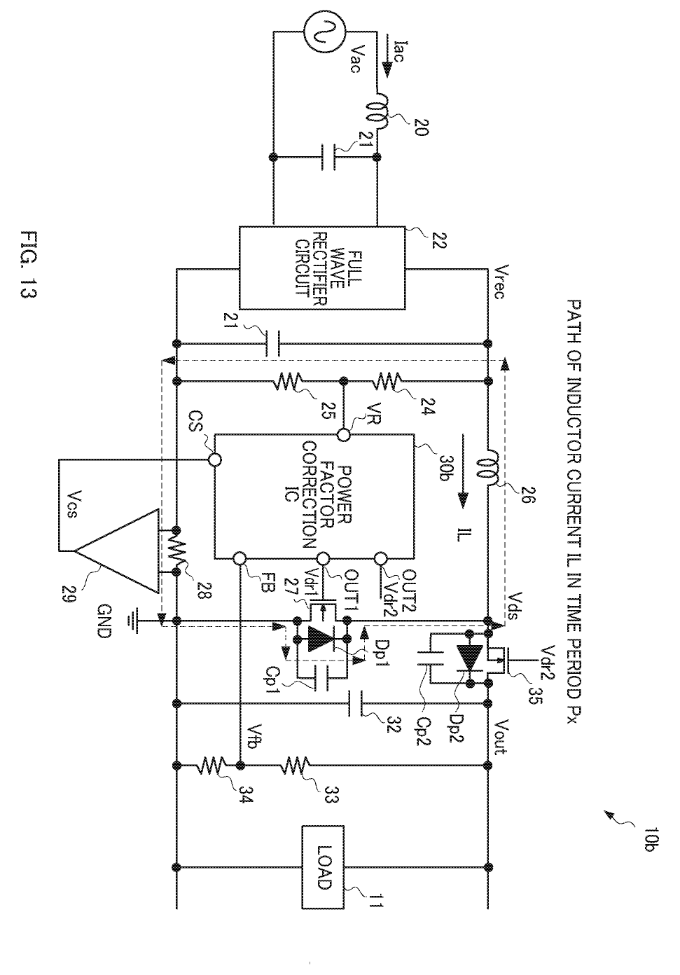

Note that in a period Px from time t4 to time t6, the parasitic diode Dp1 of the NMOS transistor 27 is turned on, and as shown in FIG. 13, the NMOS transistor 27 conducts in reverse. When the NMOS transistor 27 is turned on in this period Px, ZVS is achieved and conduction loss is reduced.

At time t7 at which a time period in accordance with the ON-period command Pon1 has elapsed since time t6, the count value Cnt1 of the counter 304 exceeds the period in accordance with the ON-period command Pon1, and accordingly, the comparator 305 outputs a high signal S1. Then, the SR flip-flop 343 outputs a low signal S2, and the delay circuit 344 outputs a low drive signal Sdrv1. After that, a similar operation is repeated.

The ON-period command Pon0 is computed as the total voltage of the command voltage VA determined based on the output voltage Vout and the voltage indicating the time period P4. The time period P4 is a time period for compensating for a substantial decrease in the ON-period caused by the inductor current flowing in the negative direction in a period starting when the NMOS transistor 27 is turned on and ending when the inductor current IL reaches the predetermined value (i.e., the period from time t5 to time t6). Specifically, the time period P4 is √(LC)/α. As mentioned above, the ON-period command Pon1 is further corrected by the time period P4 based on times t5 to t6.

Then, when the NMOS transistor 27 is turned on for a longer period of time than the ON-period command Pon1 determined by the command voltage VA and the like, the inductor current IL flows in the negative direction, and the influence of the time period is canceled out during which the NMOS transistor 27 is regarded as that it is not actually turned on (e.g., times t5 to t6). Accordingly, the average value of the inductor current IL matches the AC component of the rectified voltage Vrec, and also, the output voltage Vout is maintained at the target level more easily.

Further, when the ON-period command Pon1 is changed based on an error between the count value Cnt1 and the ON-period command Pon0 at the timing when the NMOS transistor 27 is turned off, the ON-period increases and decreases at a shorter interval than the resonant period of the filter. Thus, the average ON-period of the NMOS transistor 27 relative to the resonant period does not change stepwise.

Accordingly, a switching control circuit capable of reducing resonant current can be provided.

### Simulation Results

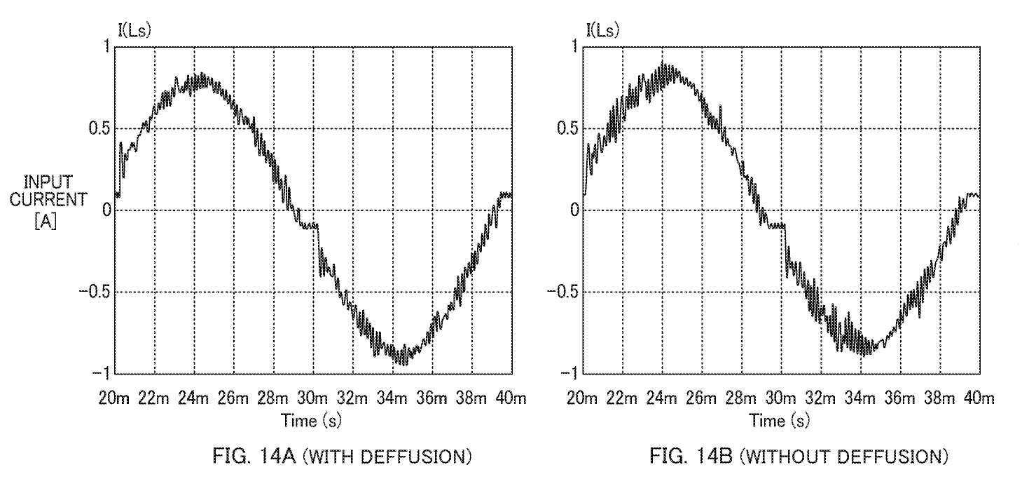

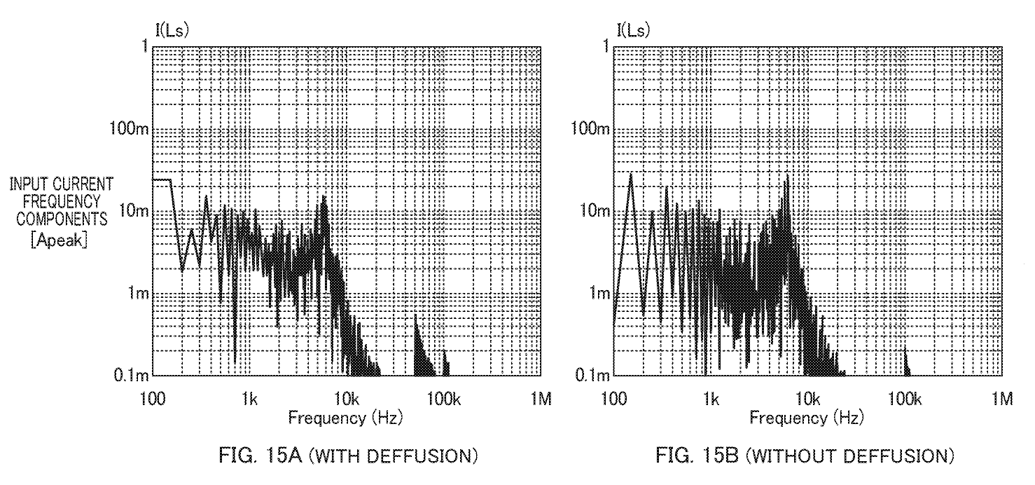

FIGS. 14A, 14B, 15A and 15B are diagrams illustrating example simulation results. The diagram in FIG. 14A shows the current Iac in a case where the ON-period command Pon1 is the ON-period command value, and the diagram in FIG. 14B shows the current Iac in a case where the ON-period command Pon0 is the ON-period command value. Similarly, the diagram in FIG. 15A shows a frequency component of the current Iac in a case where the ON-period command Pon1 is the ON-period command value, and the diagram in FIG. 15B shows a frequency component of the current Iac in a case where the ON-period command Pon0 is the ON-period command value.

The effectiveness of the correction circuit 301 is not clearly observable in a comparison between the diagrams in FIGS. 14A and 14B, but is observable in a comparison between the diagrams in FIGS. 15A and 15B. Specifically, the diagrams show that a frequency component of the input current Iac decreases around the frequency of the resonant current (e.g., 10 kHz or below). In other words, LC resonance of the filter is reduced when the ON-period command Pon1 is the ON-period command value, compared to when the ON-period command Pon0 is the ON-period command value. Accordingly, the resonant current is reduced by the correction circuit 301, which is similar to the case by the correction circuit 201.

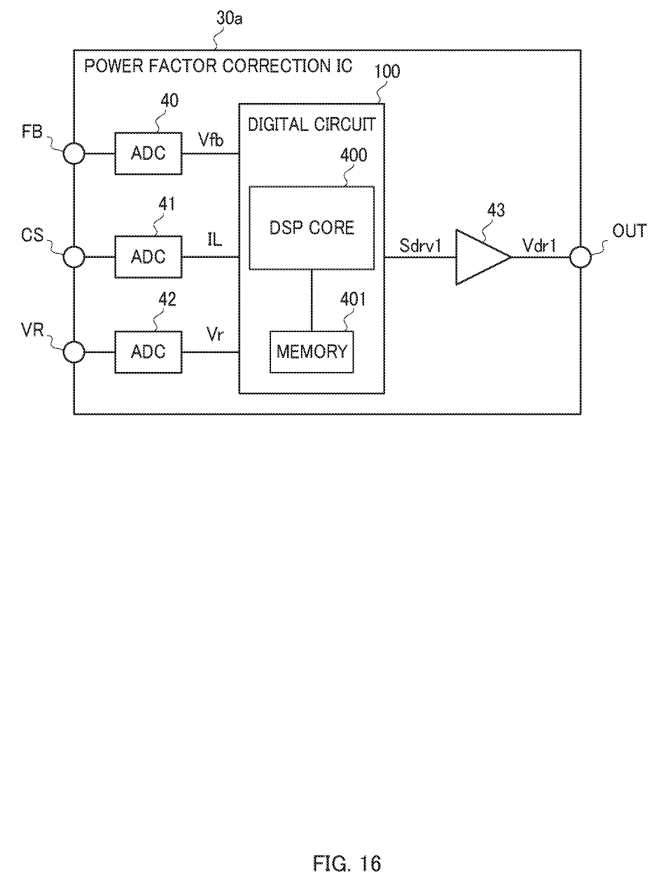

FIG. 16 is a diagram illustrating an example embodiment of DSP. The digital circuit 100 includes a DSP core 400 and memory 401 that stores programs executed by the DSP core 400 and various kinds of information. The DSP core 400 executes a program to cause the digital circuit 100 to implement various circuits and functional blocks such as an adder, a subtractor, a multiplier, a divider, a filter, and an amplifier circuit. The same applies to the digital circuit 101.

Further, the digital circuits 100, 101 may be implemented not with the DSP core 400 and the memory 401, but with a hardware logic circuit (i.e., wired logic). Also, wired logic and programmable logic may coexist.

When the DSP core 400 executes a program, the output circuit 200 corresponds to an output unit 200, and the correction circuit 201 corresponds to a correction unit 201.

### Overview

The AC-DC converters 10a, 10b of the present embodiment have been described above. The digital circuit 100 includes the output circuit 200, the correction circuit 201, the counter 202, the subtractor 203, the comparator 204, and the inverter circuit 205. This makes it possible to provide a switching control circuit capable of reducing resonant current.

Further, when the NMOS transistor 27 is turned off, the correction circuit 201 corrects the voltage VC based on the error E4 between the voltage VC and the count value Cnt0. This makes it easier to maintain the output voltage Vout at the target level.

Further, the correction circuit 201 includes the subtractor 220, the sample-and-hold circuit 221, and the adder 222. Thus, the ON-period PWd increases and decreases at an interval shorter than the resonant period of the filter, and with a simple circuit, it is possible to reduce stepwise changes in the average ON-period of the NMOS transistor 27 relative to the resonant period and to reduce resonant current.

Further, the output circuit 200 includes the subtractor 210, the voltage regulator 211, the multiplier 212, the subtractor 213, the current regulator 214, and the subtractor 215. Thus, the AC-DC converter 10a can operate in continuous conduction mode.

Further, the digital circuit 100 is favorably used in the AC-DC converter 10a.

Further, the digital circuit 101 includes the output circuit 300, the correction circuit 301, the counter 304, the output circuit 307, the comparator 305, and the drive signal output circuit 308. Thus, a switching control circuit capable of reducing resonant current even in a case where the AC-DC converter 10b operates in critical mode can be provided.

Further, the digital circuit 101 is favorably used in the AC-DC converter 10b.

The present disclosure is directed to provision of a switching control circuit capable of reducing resonant current.

The present disclosure can provide a switching control circuit capable of reducing resonant current.

Embodiment(s) of the present disclosure described above is/are simply to facilitate understanding of the present disclosure and is/are not in any way to be construed as limiting the present disclosure. The present disclosure may variously be changed or altered without departing from its essential features and encompass equivalents thereof.

What is claimed is:

1. A switching control circuit for a power supply circuit that generates an output voltage at a target level from an alternating current (AC) voltage, the power supply circuit including
an inductor configured to receive a rectified voltage that is in accordance with the AC voltage, and
a transistor configured to control an inductor current flowing through the inductor,
the switching control circuit being configured to switch the transistor of the power supply circuit, the switching control circuit comprising:
a first command value output circuit configured to output a first command value, the first command value being in accordance with the output voltage, the rectified voltage, and the inductor current;
a correction circuit configured to correct the first command value, and output a result of the correction as a second command value;
a counter configured to output a first value that increases discretely, in response to the transistor being turned on;
a comparator circuit configured to compare the second command value and the first value; and
a drive signal output circuit configured to output a drive signal to drive the transistor, based on a result of the comparison by the comparator circuit,
the correction circuit being configured to correct the first command value based on the first command value and the first value and output the second command value, every time the transistor is turned off.

2. The switching control circuit according to claim 1, wherein
the correction circuit corrects the first command value, based on an error between the first command value and the first value, in response to the transistor being turned off.

3. The switching control circuit according to claim 2, wherein
the correction circuit further includes
a subtractor configured to subtract the first value from the first command value, and output a result of the subtraction as the error,
a sample-and-hold circuit configured to sample the error and hold the error as a second value, in response to the transistor being turned off, and
an adder configured to add the first command value and the second value, and output a result of the addition as the second command value.

4. The switching control circuit according to claim 1, wherein
the first command value output circuit includes:
a second command value output circuit configured to output a third command value that corresponds to the output voltage, and
a third command value output circuit configured to output the first command value, based on the rectified voltage, the third command value, and the inductor current, and
the counter counts the first value with a predetermined period corresponding to a switching frequency of the transistor.

5. A power supply circuit configured to generate an output voltage at a target level from an alternating current (AC) voltage, the power supply circuit comprising:
an inductor configured to receive a rectified voltage that is in accordance with the AC voltage;
a transistor configured to control an inductor current flowing through the inductor; and
a switching control circuit configured to switch the transistor,
the switching control circuit including:
a first command value output circuit configured to output a first command value, the first command value output circuit being in accordance with the output voltage, the rectified voltage, and the inductor current,
a correction circuit configured to correct the first command value, and output a result of the correction as a second command value,
a counter configured to output a first value that increases discretely, in response to the transistor being turned on,
a comparator circuit configured to compare the second command value and the first value, and
a drive signal output circuit configured to output a drive signal to drive the transistor, based on a result of the comparison by the comparator circuit,
the correction circuit being configured to correct the first command value based on the first command value and the first value and output the second command value, every time the transistor is turned off.

6. A switching control circuit for a power supply circuit that includes:
an output capacitor, at which the power supply circuit generates an output voltage at a target level from an alternating current (AC) voltage,
an inductor configured to receive a rectified voltage that is in accordance with the AC voltage,
a first transistor configured to control an inductor current flowing through the inductor, the first transistor having a parasitic capacitor and an output electrode, and
a second transistor provided between the inductor and the output capacitor, the switching control circuit being configured to complementarily switch the first transistor and the second transistor,
the switching control circuit comprising:
a correction circuit configured to correct a value that is in accordance with the output voltage, and output a result of the correction as a command value;
a counter configured to output a count value that increases discretely, in response to the first transistor being turned on;
a time period output circuit configured to output a first time period from when the inductor current reaches a predetermined value to when the inductor current reaches a first predetermined value smaller than the predetermined value, in a state where the first transistor is off and the second transistor is on;
a comparator circuit configured to compare the command value and the count value; and
a drive signal output circuit configured to output a first drive signal to switch the first transistor and a second drive signal to switch the second transistor,
the correction circuit correcting the value, based on the value and the count value, and outputting the command value, every time the second transistor is turned on,
the drive signal output circuit
outputting the second drive signal to turn off the second transistor, in response to the first time period having elapsed since the inductor current reaches the predetermined value after turning off of the first transistor based on a result of the comparison by the comparator circuit, and
outputting the first drive signal to turn on the first transistor, in response to the second time period having elapsed, and
the second time period being determined based on the parasitic capacitor in the first transistor and a resonant period of the inductor, and being a time period in which a voltage level of the output electrode of the first transistor decreases to a predetermine level.

7. A power supply circuit, comprising:
an output capacitor, at which the power supply circuit generates an output voltage at a target level from an alternating current (AC) voltage;
an inductor configured to receive a rectified voltage that is in accordance with the AC voltage;
a first transistor configured to control an inductor current flowing through the inductor, the first transistor having a parasitic capacitor and an output electrode;
a second transistor provided between the inductor and the output capacitor; and
a switching control circuit configured to complementarily switch the first transistor and the second transistor,
the switching control circuit including
a correction circuit configured to correct a value that is in accordance with the output voltage, and output a result of the correction as a command value,
a counter configured to output a count value that increases discretely, in response to the first transistor being turned on,
a time period output circuit configured to output a first time period from when the inductor current reaches a predetermined value to when the inductor current reaches a first predetermined value smaller than the predetermined value, in a state where the first transistor is off and the second transistor is on;
a comparator circuit configured to compare the command value and the count value; and
a drive signal output circuit configured to output a first drive signal to switch the first transistor and a second drive signal to switch the second transistor,
the correction circuit correcting the value, based on the value and the count value, and outputting the command value, every time the second transistor is turned on,
the drive signal output circuit
outputting the second drive signal to turn off the second transistor, in response to the first time period having elapsed since the inductor current reaches the predetermined value after turning off of the first transistor based on a result of the comparison by the comparator circuit, and
outputting the first drive signal to turn on the first transistor, in response to the second time period having elapsed, and
the second time period being determined based on the parasitic capacitor in the first transistor and a resonant period of the inductor, and being a time period in which a voltage level of the output electrode of the first transistor decreases to a predetermine level.
